(19) United States
(12) Patent Application Publication
(10) Pub. No.: US 2025/0310761 A1
(43) Pub. Date: Oct. 2, 2025

(54) SECURE AI AUTHENTICATION AND INTERACTION

(71) Applicant: Microsoft Technology Licensing, LLC, Redmond, WA (US)

(72) Inventors: Charbel KHAWAND, Sammamish, WA (US); Andrew James HILLENIUS, Woodinville, WA (US)

(21) Appl. No.: 18/618,383

(22) Filed: Mar. 27, 2024

(51) Int. Cl. H04W 12/06; H04W 12/63

(52) U.S. Cl. CPC H04W 12/06; H04W 12/63

(57) ABSTRACT

Secure AI authentication is implemented for selectable environments with a selectable combination of ML models processing selectable input credentials, e.g., biometric and/or non-biometric credentials, such as a key associated with a secure model, user location information, a user gesture credential, and/or a user movement pattern credential. ML models may be selectively applied in serial or parallel in a selected authorization procedure. ML model applicability may vary based on one or more parameters, such as time of day, or one or more detected input credentials, such as user gestures, secure model keys, or biometric voice or face recognition. For example, AI authorization (e.g., for biometric credentials) augmented with an ultra-wideband (UWB) communication protocol provides robust user authentication via a native cryptographic exchange and accurate user location credentials for proximity and geo-fenced confirmation of other user credentials, such as biometric credentials, thereby preventing false positives by spoofing.

### BACKGROUND

“Authentication” is the act of proving an assertion such as the identity of a computer system user. In contrast with identification, which is the act of indicating identity, authentication is the process of verifying that identity. Various techniques are used in computer systems to perform authentication of a user, such as by receiving a passcode provided by the user, detecting a biometric factor associated with the user, a communication exchanged with a device of the user, etc. The received factor of the user may be compared to a known factor of the user to authenticate the user. “Single-factor” authentication may be performed, which uses a single received aspect (e.g., a passcode) to authenticate the user, or “multi-factor” authentication may be performed, which uses multiple received aspects (e.g., passcode and fingerprint) to authenticate the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Secure artificial intelligence (AI) authentication and interaction is disclosed herein. AI authorization augmented with an ultra-wideband (UWB) communication protocol provides robust user authentication via a native cryptographic exchange and accurate user location for proximity and geo-fenced interaction. Authentication utilizing UWB-enabled devices provides a wireless and seamless extension of security provided by secure platforms modules. AI systems combined with accurate and secure position sensing enable secure user access to user information without requiring deliberate user authentication. User privacy is maintained by using cryptography to obfuscate unique identifiers in broadcast beacons. Real time location data from UWB communications, such as Time of Flight (ToF) and Angle of Arrival (AoA), provides high precision, and improves the context of user credential information provided to AI engines.

In one aspect, a method of selectively creating, training and deploying ML models for user authorization, identification, or access, comprises: enabling selection of at least one non-contact input from a plurality of non-contact inputs and at least one user location input from a plurality of user location inputs for an authentication model for the user; receiving the at least one non-contact input and the at least one user location input; training the authentication model based on the received at least one non-contact input and the received at least one user location input to generate a trained user authentication model; and selecting at least one trained user authentication model from a plurality of trained user authentication models for deployment in an ML user authorization engine.

According to another aspect, a method of using ML models for user authorization, identification, or access, comprises: detecting, by a computing system, biometric information of a user; receiving non-biometric information from a user associated device; generating a request to at least one ML model configured to perform a user authentication analysis, wherein the request includes the biometric information and the non-biometric information; receiving at least one response from the at least one ML model; and authenticating the user based on the at least one response from the at least one ML model. Selection of the at least one ML model for the request may vary based on at least one of the biometric information or the non-biometric information. Selection of at least one of the biometric information from a plurality of biometric information or the non-biometric information from a plurality of non-biometric information may vary based on at least one parameter.

According to still another aspect, a system comprises a location detector, a non-location detector, and an authenticator. The location detector is configured to wirelessly detect at least one user location credential. The non-location detector is configured to wirelessly detect at least one non-location credential of a user. The authenticator is configured to generate a request to at least one machine learning (ML) model configured to perform a user authentication analysis, wherein the request includes the at least one user location credential and the at least one non-location credential; receive at least one user authentication response from the at least one ML model; and determine whether to authenticate the user based on the at least one user authentication response from the at least one ML model.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example system configured for secure artificial intelligence (AI) authentication and interaction, in accordance with embodiments.

FIG. 2 shows a block diagram of an example system configured for creating, training, and selectively deploying machine-learning models with biometric and/or non-biometric inputs for user authorization, identification, or access, in accordance with an embodiment.

FIG. 3 shows a block diagram of an example system configured for creating, and training machine-learning models with selectable combinations of biometric and/or non-biometric inputs for user authorization, identification, or access, in accordance with an embodiment.

FIGS. 4A and 4B each show a diagram of an example system configured for using machine-learning models with biometric and/or non-biometric inputs for user authorization, identification, or access, in accordance with embodiments.

FIG. 5A shows a flowchart of a process for selectively creating, training and deploying ML models for user authorization, identification, or access, in accordance with an embodiment.

FIG. 5B shows a flowchart of a process for using ML models for user authorization, identification, or access, in accordance with an embodiment

FIG. 6 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Various techniques are used in computer systems to perform authentication of a user, such as receiving a passcode provided by the user, a physical biometric factor associated with the user (e.g., a fingerprint, an image such as a facial scan), a behavior-related biometric factor associated with the user (e.g., keyboard dynamics, gait recognition, hand gestures), a device of the user (e.g., an ID card, a security token) etc. The received factor of the user is compared to a known factor of the user to authenticate the user. Single-factor authentication may be performed, which uses a single received factor to authenticate the user, or multi-factor authentication may be performed, which uses multiple received factors to authenticate the user.

Artificial intelligence (AI) relates to the configuration of machines (implemented in hardware and/or software) perform tasks/functions in an intelligent manner similar to intelligent beings (e.g., similar to human thinking), including performing tasks/functions that historically required human intelligence.

User authentication, such as image recognition, is prone to spoofing or false triggering, which causes security challenges and user experience degradation. AI features, such as large language models (LLMs) for voice detection and identification, may be used for various hands-fee automation of authentication. However, security is a significant concern for generative AI (i.e., AI capable of generating content such as text, images, or other data, often in response to prompts) and hands-free systems that aim to minimize user interactions with secure systems. AI image and voice processing provides modest security, achieving false positive rates around 1:1000, and are susceptible to spoofing, which limits their use to low security applications, such as a home voice assistant with a limited number of users in a trusted environment.

Embodiments described herein enable secure AI authentication and interaction. Authentication, such as through image recognition or AI detection models, is implemented with a security algorithm, such as those using cryptography. For example, AI authorization augmented with an ultra-wideband (UWB) communication protocol provides robust user authentication via a native cryptographic exchange and accurate user location for proximity and geo-fenced interaction. Authentication utilizing UWB-enabled devices provides a wireless and seamless extension of security provided by secure platforms modules (e.g., smart cards, trusted platform modules (TPMs), and Secure Elements) used in payment, enterprise systems, and other secure environments. AI systems combined with accurate and secure position sensing (e.g., enabled by UWB signaling) enables secure user access to secure accounts, files, payment, identity sensitive applications, etc. without requiring deliberate user authentication. User privacy can be maintained by using cryptography to obfuscate unique identifiers in broadcast beacons. Real time location data from UWB communications, such as Time of Flight (ToF) and Angle of Arrival (AoA) provides high precision (e.g., within 5 cm or 5 degrees), can be used to improve the context of user credential information provided to AI engines, such as voice, audio, and/or other metadata.

For example, UWB metadata may be added to an AI voice command or image log-in to confirm to the secure system that the person claiming access is authenticated and that his/her location is within a pre-programmed geo-fence position. Examples of training inputs for ML model training include additional out of band information such as user position, angle, gesture, time of day, location, user crypto, etc. In this manner, inference performed by the ML model correlates to such inputs being true.

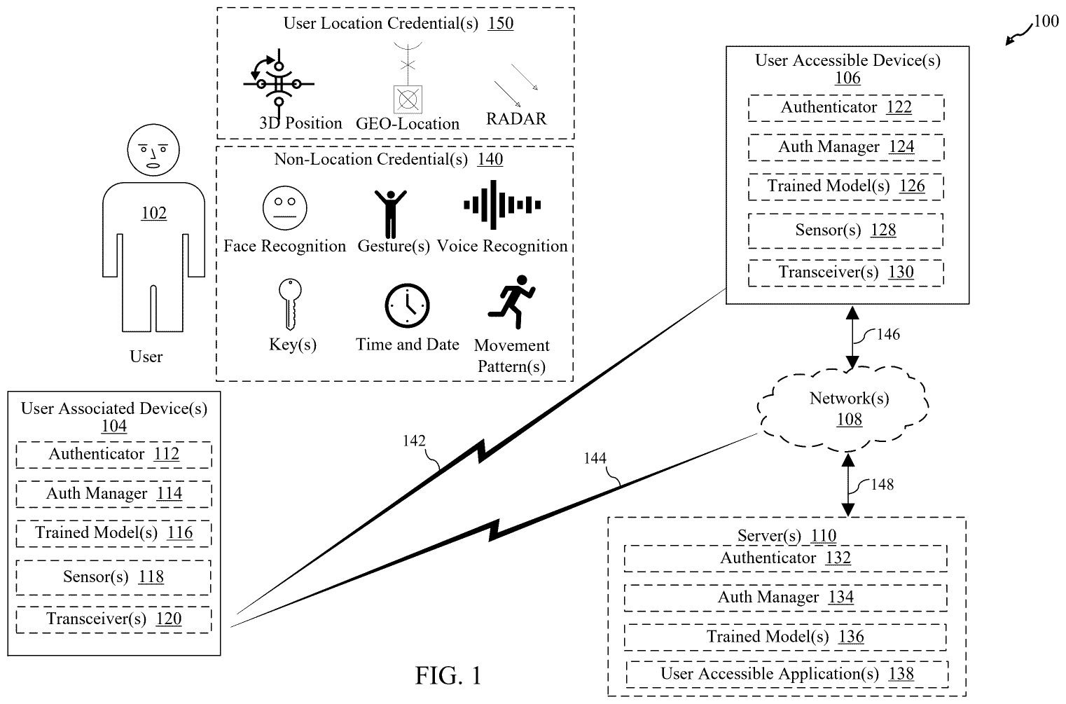

The above mentioned embodiments may be implemented in various ways. To help illustrate such embodiments, and further embodiments, FIGS. 1-6 are described as follows. In particular, FIG. 1 shows a block diagram of an example system 100 configured for secure artificial intelligence (AI) authentication and interaction, in accordance with embodiments. System 100 includes one or more user associated devices 104, one or more user accessible devices 106, one or more networks 108, and one or more servers 110. Each of user associated device(s) 104 includes an authenticator 112, an authorization manager 114, one or more trained model(s) 116 (also referred to as machine learning (ML) models), one or more sensor(s) 118, and one or more transceivers 120. Each of user accessible device(s) 106 includes an authenticator 122, an authorization manager 124, one or more trained model(s) 126, one or more sensor(s) 128, and one or more transceivers 130. Each server of server(s) 110 includes an authenticator 132, an authorization manager 134, one or more trained model(s) 136, and one or more user accessible applications 138. Dashed lines indicate components or subcomponents may or may not be present in a variety of implementations. These features of FIG. 1 are described in further detail as follows.

Authenticator 112 may implement user authentication procedures based on authentication logic. In an embodiment, authenticator 112 is configured to control or participate in a process to use trained model(s) 116, 126, and/or 136 to determine whether user 102 is authorized or identified by user accessible device(s) 106. Authenticator 112 may operate alone or in conjunction with (e.g., as an agent of) authenticator 122 and/or authenticator 132. Authenticator 112 may detect, determine, receive, or send user credentials or other information associated with user 102 for processing by trained model(s) 116, 126, or 136.

In embodiments, authentication manager 114 is configured to enable creation, training, and deployment of trained model(s) 116 for user authorization in one or more user accessible environments 106. Authorization manager 114 may enable an environment administrator (e.g., user 102) to select authorization model inputs for one or more models and selectively deploy one or more trained models 116 with authentication logic for implementation by authenticator 112. For example, authorization manager 114 may enable selection of at least one (e.g., non-contact) input from multiple non-contact inputs (e.g., biometric input, non-biometric input) and at least one user location input from multiple user location inputs (e.g., non-biometric input) for an authentication model for the user. Authorization manager 114 receives the non-contact input(s) and the location input(s) for training. Authorization manager 114 trains the authentication model(s) based on the received non-contact input(s) and user location input(s) to generate a trained user authentication model.

Each trained model of trained model(s) 116 is trained on a wide variety of inputs referred to as user credentials, such as biometric, non-biometric, location, non-location, contactless, contact, and so on. For example, as shown in FIG. 1, user credentials (e.g., to create untrained models, to train models, and to generate trained model inferences) include user location credential(s) 150, such as three dimensional (3D) position, geo-location, and/or RADAR scans, detected proximity, presence detection, etc. and/or non-location credential(s) 140, such as facial recognition, iris recognition, fingerprint acquisition, voice recognition, gesture(s), movement pattern(s), key(s), and/or time and date. User location credential(s) 150 provide assurance the user is near a user accessible device 106, and thus is the user from which non-location credential(s) 140 are obtained. Biometric credentials with greater accuracy, such as fingerprint acquisition, iris recognition, and voice recognition, provide for greater accuracy in user authentication. Keys include, for example, public keys, private keys, cloud keys, and/or secure shell (SSH) keys. Trained model(s) 116 may be secure or unsecure. Secure trained model(s) 116 are signed using one or more keys (e.g., model authentication key), for example. In examples, trained model(s) 116 are user-specific.

Sensor(s) 118 include a wide variety of sensors used to detect information pertaining to one or more user credentials, such as a camera, a microphone, a fingerprint reader, an accelerometer, a global positioning system (GPS) sensor, a presence detector (e.g., RADAR), and so on.

Transceiver(s) 120 provide wireless and/or wired communication, for example, communication 142 between user associated device(s) 104 and user accessible device(s) 106 and/or communication 144 between user associated device(s) 104 and network(s) 108. Communication may be provided by a wired or wireless network interface, such as, for example, one or more of the following wired or wireless interfaces: a UWB interface, an IEEE 802.11 wireless LAN (WLAN) wireless interface (e.g., a Wi-Fi interface), a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. For example, user associated device(s) 104 is/are UWB-enabled device(s). Further examples of network interfaces that may be incorporated in user associated device(s) 104 are described elsewhere herein. Communications 142, 144 may pertain, for example, to user credentials, model creation, training, deployment, and/or use, model inferences, authentication/authorization determinations, sensed information, etc.

User associated device(s) 104 comprise one or more passive or active devices that transmit one or more user authorization, identification, or access credentials, such as a tag, a badge, a cellular phone, a beacon, a fob, a watch, a pen, a wearable device, etc. In examples, user associated device(s) 104 include a secure platform module, such as one or more of the following: a trusted platform module (TPM), a smart card, or a secure element. User associated device(s) 104 may be paired with a (e.g., biometric) chain of trust. For example, a chain of trust may determine if user associated device(s) 104 was removed or left somewhere between interactions, such as since the last interaction with user accessible device(s) 106.

In examples, user associated device(s) 104 may be UWB enabled secure devices with or without secure hardware, such as a secure element. In some examples, UWB-enabled secure user associated device 104 captures (e.g., samples or detects) biometric or other information. For example, UWB-enabled secure user associated device 104 collects fingerprint or other biometric information from user 102. UWB-enabled secure user associated device 104 is configured to provide biometric or other information to user accessible device(s) 106 as one or more user credentials for authorization.

User accessible device(s) 106 are any type of device utilizing user identification or authorization. User accessible device(s) 106 is/are fixed or mobile, such as a mobile phone or other mobile computing environment, a desktop computer, an operating system, a network environment, a building, an automobile, and so on. In some examples, a user accessible device is a computing system permitting authorized users to access a computing device, a computing network, a computing service (e.g., cloud service), computing resources, data, etc. In some examples, user accessible device(s) 106 is/are configured to pair or not pair an input, output, or peripheral device (e.g., pen, mouse, keyboard, headset) with a computing system based on a user determination. In some examples, user accessible device(s) 106 may be a financial or payment system permitting authorized user to access user records, make or receive payments, etc.

Authenticator 122 implements user authentication procedures based on authentication logic. Authenticator 122 may be configured to control or participate in a process to use trained model(s) 116, 126, and/or 136 to determine whether user 102 is authorized or identified by user accessible device(s) 106. Authenticator 122 may operate alone or in conjunction with (e.g., as an agent of) authenticator 132. Authenticator 122 may detect, determine, receive, or send user credentials or other information associated with user 102 for processing by trained model(s) 126.

In an embodiment, authentication manager 124 is configured to enable creation, training, and deployment of trained model(s) 126 for user authorization in one or more user accessible environments 106. Authorization manager 124 may enable an environment administrator (e.g., user 102) to select authorization model inputs for one or more models and selectively deploy one or more trained models 126 with authentication logic for implementation by authenticator 122. For example, authorization manager 124 may enable selection of at least one (e.g., non-contact) input from multiple non-contact inputs (e.g., biometric input, non-biometric input) and at least one user location input from multiple user location inputs (e.g., non-biometric input) for an authentication model for the user. Authorization manager 124 may receive the non-contact input(s) and the location input(s) for training. Authorization manager 124 may train the authentication model(s) based on the received non-contact input(s) and user location input(s) to generate the trained user authentication model(s) 136. The generation of an authentication model using both location credentials and non-location credentials enables enhanced accuracy in authentication, because the location credentials determined for a user at a particular location (by a user associated device 104 of the user) provide assurance that this actual user is in the vicinity of the user accessible device 106 to which the user is trying to gain access. Thus, an authentication model trained on both location credentials and non-location credentials enables higher accuracy authentication of users.

Trained model(s) 126 may be trained on a wide variety of inputs referred to as user credentials, such as biometric, non-biometric, location, non-location, contactless, contact, and so on. For example, as shown in FIG. 1, user credentials include user location credential(s) 150, such as three dimensional (3D) position, geo-location, and/or RADAR, and/or non-location credential(s) 140, such as face recognition, voice recognition, gesture(s), movement pattern(s), key(s), and/or time and date. Keys include, for example, public keys, private keys, cloud keys, and/or secure shell (SSH) keys. Trained model(s) 126 may be secure or unsecure. Secure trained model(s) 126 may be signed using one or more keys (e.g., model authentication key), for example. Trained model(s) 126 may be user-specific.

Sensor(s) 128 include one or more of a wide variety of sensors that may be used to detect information pertaining to one or more user credentials, such as a camera, a microphone, a fingerprint reader, an accelerometer, a global positioning system (GPS) sensor, a presence detector (e.g., RADAR), and so on.

Transceiver(s) 130 provide wireless and/or wired communication, for example, communication 142 between user associated device(s) 104 and user accessible device(s) 106 and/or communication 146 between user accessible device(s) 106 and network(s) 108. Communication may be provided by a wired or wireless network interface, such as, for example, one or more of the following wired or wireless interfaces: a UWB interface, an IEEE 802.11 wireless LAN (WLAN) wireless interface (e.g., a WiFi interface), a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. For example, user accessible device(s) 106 and user associated device(s) 104 may be UWB-enabled. Further examples of network interfaces that may be incorporated in user accessible device(s) 106 and user associated device(s) 104 are described elsewhere herein.

Network(s) 108 comprises one or more networks such as local area networks (LANs), wide area networks (WANs), Public Land Mobile Networks (PLMNs), enterprise networks, the Internet, etc., and may include one or more of wired and/or wireless portions. User associated device(s) 104, user accessible device(s) 106, and/or server(s) 110 may communicate with each other via network(s) 108 to implement ML model creation, training, deployment, and/or user authorization.

Server(s) 110 comprises one or more computing devices, servers, services, local processes, remote machines, web services, etc. configured for executing authenticator 132 and/or authorization manager 134, storing trained model(s) 136, and/or providing user accessible application(s) 138. In an example, server(s) 110 comprises a server located on an organization's premises and/or coupled to an organization's local network, a remotely located server, a cloud-based server (e.g., one or more servers in a distributed manner), or any other device or service that may host, manage, and/or provide resource(s) for execution of authenticator 132, authorization manager 134, and/or user accessible application(s) 138. Server(s) 110 may be implemented as a plurality of programs executed by one or more computing devices. In examples, user accessible application(s) 138 include computer network applications (e.g., word processing, job processing), real estate access card readers, financial/banking applications, etc.

Authenticator 132 may implement user authentication procedures based on authentication logic. Authenticator 132 may be configured to control or participate in a process to use trained model(s) 116, 126, and/or 136 to determine whether user 102 is authorized or identified by user accessible device(s) 106 or user accessible application(s) 138. Authenticator 132 may operate alone or in conjunction with authenticator 112 and/or 122 in various implementations. Authenticator 132 may receive user credentials or other information associated with user 102 for processing by trained model(s) 136.

Authentication manager 134 may be configured to enable creation, training, and/or deployment of trained model(s) 136 for user authorization in one or more user accessible devices 106 or user accessible applications 138. Authorization manager 134 may enable an environment administrator (e.g., user 102) to select authorization model inputs for one or more models and selectively deploy one or more trained models 136 with authentication logic for implementation by authenticator 132. For example, authorization manager 134 may enable selection of at least one (e.g., non-contact) input from multiple non-contact inputs (e.g., biometric input and/or non-biometric input) and at least one user location input from multiple user location inputs (e.g., non-biometric input) for an authentication model for the user 102. Authorization manager 134 may receive the non-contact input(s) and the location input(s) for training. Authorization manager 134 may train the authentication model(s) based on the received non-contact input(s) and user location input(s) to generate the trained user authentication model(s) 136.

Trained model(s) 136 may be trained on a wide variety of inputs referred to as user authorization credentials, such as biometric, non-biometric, location, non-location, contactless, contact, and so on. For example, as shown in FIG. 1, user credentials include user location credential(s) 150, such as three dimensional (3D) position, geo-location, and/or RADAR, and/or non-location credential(s) 140, such as face recognition, voice recognition, gesture(s), movement pattern(s), key(s), and/or time and date. Keys include, for example, public keys, private keys, cloud keys, and/or secure shell (SSH) keys. Trained model(s) 136 may be secure or unsecure. Secure trained model(s) 136 may be signed using one or more keys (e.g., model authentication key), for example. Trained model(s) 136 may be user-specific.

Example system 100 shows a multitude of configurations where secure elements (e.g., security modules) and transceiver(s) (e.g., UWB transceiver) in user associated device(s) 104 can be used to provide cryptographically hardened secure interaction of user 102 with selectable trained model(s) 116, 126, or 136 configured to process selectable user credentials using one or more computing systems at one or more locations.

UWB provides useful metadata for contextual inputs to trained model(s) 116, 126, 136, such as time of flight and angle of arrival, which may be used as user location credentials to verify a location or proximity of user 102, allowing the trained model(s) 116, 126, 136 to geofence around user 102 and user associated device(s) 104.

In an example, user accessible device(s) 106 may authenticate user 102 to determine authorization for user 102 to use user associated device(s) 104 to check a bank balance provided by user accessible device(s) 106. In an embodiment, user associated device(s) 104 and user accessible device(s) 106 include at least one UWB-enabled device. There may be additional people in the room area with user 102. Authenticator 122 may verify which person is which (e.g., center, right, left) and distance from user accessible device(s) 106 to determine whether the interaction with user 102 and/or user associated device(s) 104 providing credentials is secure. For example, user accessible device(s) 106 may receive biometric information/user credentials for user 102 and then proceed to determine a proximity of user 102 and/or user associated device(s) 104 based on the received biometric information. Authenticator 122 may determine whether user 102 is authenticated based on inferences provided by one or more trained models 126 based on the biometric and proximity information/user credentials provided for authentication/authorization.

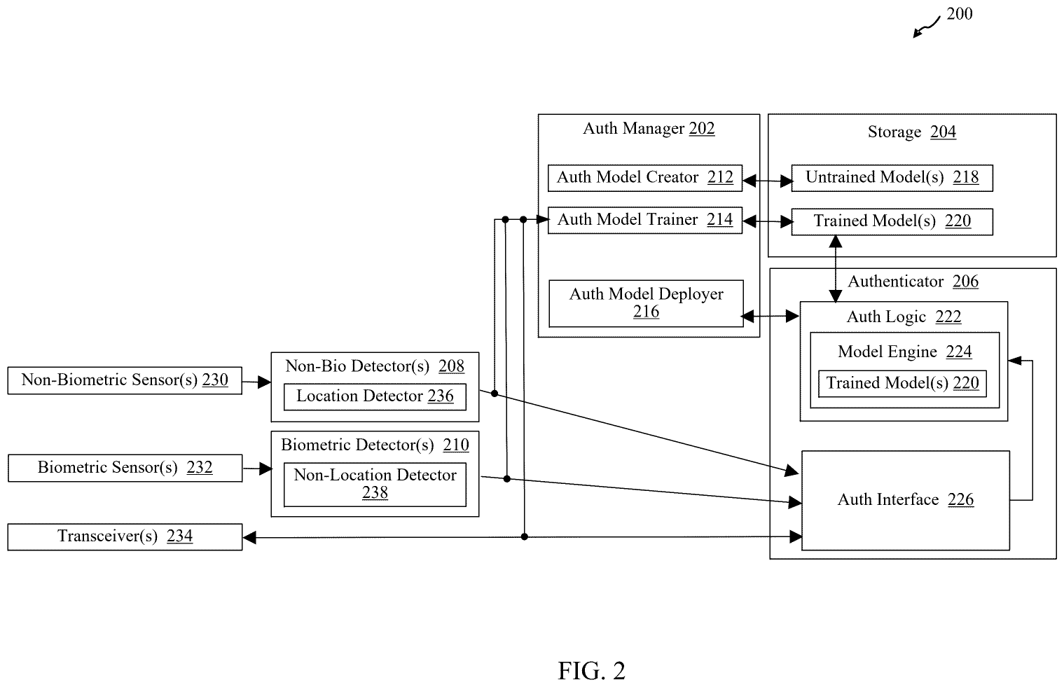

FIG. 2 shows a block diagram of an example system 200 configured for creating, training, and selectively deploying machine-learning models with biometric and/or non-biometric inputs for user authorization, identification, or access, in accordance with an embodiment. User associated device(s) 104, user accessible device(s) 106, and/or server(s) 110 shown in FIG. 1 may be configured according to system 200. As shown in FIG. 2, system 200 includes an authorization manager 202, a storage 204, and an authenticator 206, one or more non-biometric detectors 208, one or more biometric detector(s) 210, one or more non-biometric sensors 230, one or more biometric sensors 232, and one or more transceivers 234. Authorization manager 202 includes an authorization model creator 212, an authorization model trainer 214, and an authorization model deployer 216. Storage 204 stores one or more untrained models 218 and one or more trained models 220.

Authenticator 206 includes an authorization logic 222 and an authorization interface 226. Non-biometric detector(s) 208 includes a location detector 236. Biometric detector(s) 210 includes a non-location detector 238. Authorization logic 222 includes a model engine 224, which executes one or more of trained model(s) 220. Authorization manager 202 is an example of each of authorization managers 114, 124, and 134 of FIG. 1. Authenticator 206 is an example of each of authenticators 112, 122, and 132 of FIG. 1. Trained model(s) 220 are examples of trained models 116 and 126 of FIG. 1. Biometric sensor(s) 232 and non-biometric sensors 230 are examples of sensors 118 and 128 of FIG. 1. Transceiver(s) 234 is an example of transceivers 120 and 130 of FIG. 1. System 200 is described in further detail as follows.

Authentication manager 202 may be configured to enable creation of untrained model(s) 218, training of untrained model(s) 218 into trained model(s) 220, and deployment of trained model(s) 220 for user authorization in one or more user accessible environments 106 shown by example in FIG. 1.

Authorization model creator 212 may enable an environment administrator (e.g., user 102) to select user authorization model inputs for one or more untrained models 218. For example, authorization model creator 212 may enable selection of at least one input (e.g., biometric input, non-biometric input) from multiple inputs and at least one user location input (e.g., non-biometric input) from multiple user location inputs to create each untrained model 218 for user 102. The selected inputs may be referred to as user credentials. User credentials may be, for example, biometric, non-biometric, location, non-location, contactless, contact, and so on. For example, user credentials include user location credential(s), such as three dimensional (3D) position, geo-location, and/or RADAR, proximity, presence detection, etc. and/or non-location credential(s), such as face recognition, voice recognition, gesture(s), movement pattern(s), key(s), and/or time and date. Keys include, for example, public keys, private keys, cloud keys, and/or secure shell (SSH) keys.

In some examples, authorization model creator 212 may configure a model to infer authentication if a user associated device is within a tolerable distance or proximity from a user or the user accessible environment, such as 15 feet away on a desk (e.g., showing no movement based on accelerometer). Training data sets may indicate pass/fail authentication based on a variety of proximities. For example, if the user provided a biometric voice print and a proximity to a phone/user associated device, an indication that the voice signature is coming from a significantly disparate location may result in an authorization failure.

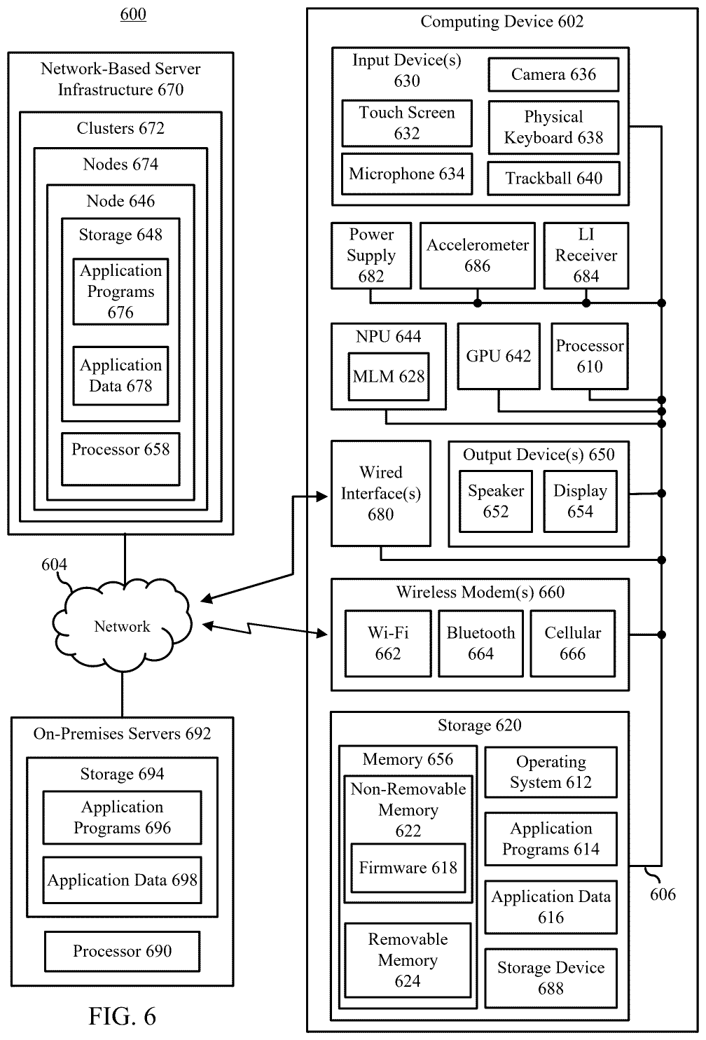

Authorization model trainer 214 may request and receive the selected input(s) (e.g., biometric input, non-biometric input) and the location input(s) for training, for example from non-biometric detector(s) 208, biometric detector(s) 210, and/or from transceiver(s) 234 (e.g., UWB transceiver AoA and/or ToF metadata). Authorization model trainer 214 may train the untrained model(s) 218 based on the selected and received inputs to generate the trained model(s) 220 for user authentication deployment. Authorization model trainer 214 may receive user credentials or other information associated with user 102 from non-biometric detector(s) 208, biometric detector(s) 210, and/or transceiver(s) 234. An untrained model 218 may be pre-trained by authorization model trainer 214 using training data such as one or more of biometrics, location, angles, etc. to generate a trained model 220. Alternatively, or additionally, a trained model 220 may be subsequently retrained by authorization model trainer 214 in the situation the trained model 220 needs to be updated, added to, or modified based on subsequently received training data. Further detail on ML model training that may be performed by authorization model trainer 214 is provided elsewhere herein, including with respect to FIG. 6 described further below.

Authorization model trainer 214 may be used to retrain ML models for dynamic inputs (e.g., user credentials). For example, authorization model trainer 214 may retrain an ML model for one or more dynamically changing keys.

Authorization model deployer 216 may enable an environment administrator (e.g., user 102) to selectively deploy one or more trained models 220 with authentication logic 222 for implementation by authenticator 206. For example, an environment administrator may select one or more applicable user accessible environments (e.g., computing device OS, cloud resources, building, automobile, financial application), select one or multiple trained models 220, indicate how multiple models are applied (e.g., serially, in parallel, alternative (OR) combinations, and so on), select model inference thresholds for pass and fail, select applicable dates and times, and so on to configure one or more user authentication procedures for user 102. The configured user authentication procedure(s) is (are) deployed/provided to authenticator 206 for implementation.

In some examples, authorization model deployer 216 may be used to combine or arrange a series of authentication procedures that vary based on one or more inputs, such as day, time of day, location, or other information. In some examples, authorization model deployer 216 may be used to combine a series of models, such as first a proximity credential, then a security code or key, then a user gesture or pattern, and so on. In some examples, authorization model deployer 216 may be used to combine model outputs (e.g., inference percentages, logic values such as zero or one) in a logic-based decision-making process based on admin/user specification, such as only one in the alternative (e.g., either or), multiple partial (e.g., at least two of three), or all (e.g., all three values at one and/or all three values at or exceeding respective thresholds), and so on.

Storage 204 may store untrained model(s) 218 created by authorization model creator 212 for retrieval by authorization model trainer 214. Storage 204 may store trained model(s) 220 generated by authorization model trainer 214 for retrieval by authorization model deployer 216 and/or authenticator 206. Trained model(s) 220 may be secure or unsecure. Secure trained model(s) 220 may be signed using one or more keys (e.g., model authentication key), for example. Trained model(s) 220 may be trained to be user-specific, such as by using biometric credentials.

Authenticator 206 may implement one or more deployed user authentication procedures based on authentication logic and one or more trained models 220 according to deployment(s) indicated by authorization model deployer 216. Authenticator 206 may be provided as a service. Authenticator 206 includes, for example, authorization logic 222 and authorization interface 226.

Authorization logic 222 includes or controls model engine 224. Authenticator 206 uses the deployment indicated by authorization model deployer 216 to configure authorization logic 222 to implement a user authorization procedure using the one or more trained models 220 indicated in the deployment to determine whether user 102 is authenticated, authorized, or identified by the one or more user accessible device(s) 106 indicated in the deployment. Authorization logic 222 may load the deployed trained models 220 for model engine 224 to execute.

Authorization logic 222 may receive user credentials or other information associated with user 102 from authorization interface 226. Authorization interface 226 receives user credentials from non-biometric detector(s) 208, biometric detector(s) 210, and transceiver(s) 234. Non-biometric detector(s) 208 receives non-biometric sensor signals from non-biometric sensor(s) 230, such as sensed location information (e.g., GPS, cellular signals, proximity information, etc.), accelerometer, etc. Non-biometric detector(s) 208 is configured to process (e.g., convert from analog to digital, normalize, scale, etc.) the received non-biometric signals for use by authorization interface 226 and authorization model trainer 214. Biometric detector(s) 210 receives biometric sensor signals from biometric sensor(s) 232, such as camera, microphone, etc. Authorization interface 226 may receive user credentials from transceiver(s) 234, such as UWB AoA, UWB ToF, encryption key, etc. Biometric detector(s) 210 is configured to process (e.g., convert from analog to digital, normalize, scale, etc.) the received biometric signals for use by authorization interface 226 and authorization model trainer 214.

Non-biometric sensor(s) 230 include a wide variety of sensors that may be used to detect information pertaining to one or more non-biometric user credentials, such as an accelerometer, a global positioning system (GPS) sensor, a presence detector (e.g., RADAR), and so on. When present, location detector 236 is configured to detect, based on sensor information, a location of the user. In an example, location detector 236 of non-biometric detector(s) 208 receives a location-related information signal from non-biometric sensor(s) 230, such as sensed GPS information, which location detector 236 may use for location determination of the device that contains non-biometric sensor(s) 230 (e.g., a user associated device 104, a user accessible environment 106). For instance, location detector 236 may be configured similarly to location information receiver 684 described further below for purposes of location determination or may be configured otherwise for location determination (e.g., by proximity detection, RADAR, etc.).

Biometric sensor(s) 232 include a wide variety of sensors that may be used to detect information pertaining to one or more biometric user credentials, such as a camera, a microphone, a fingerprint reader, and so on. When present, non-location detector 238 is configured to detect, based on sensor information, aspects of a user that do not indicate a location of the user. In an example, non-location detector 238 of biometric detector(s) 210 receives a non-location-related information signal from biometric sensor(s) 232, such as an image or stream of images/video (captured by camera, facial scanner, etc.), a voice/sound signal (captured by one or more microphones), an acceleration signal (captured by an accelerometer), a fingerprint image (captured by a fingerprint reader), etc.

Note that in an embodiment, one or more non-location detectors 238 may additionally or alternatively be included in non-biometric detector(s) 208 for the purposes of detecting non-biometric information regarding a user that is not directly related to location, such as voice, a facial scan, a fingerprint, a passcode (password or key), etc.

Transceiver(s) 234 provide wireless and/or wired communication via a wired or wireless interface, such as one or more of the following: a UWB interface, an IEEE 802.11 wireless LAN (WLAN) wireless interface (e.g., a Wi-Fi interface), a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. For example, user associated device(s) 104 may be UWB-enabled device(s). Further examples of network interfaces that may be incorporated in user associated device(s) 104 are described elsewhere herein. Communications by transceiver(s) 234 may pertain, for example, to user credentials, model creation, training, deployment, and/or use, model inferences, authentication/authorization determinations, sensed information, etc.

Authorization logic 222 may provide received user credentials to model engine 224. Trained models 220 may process the received user credentials to generate inferences indicating, for example, a confidence level whether the received user credentials match trained user credentials. Authorization logic 222 may apply the model inferences to the deployed logic to determine whether the user is authenticated based on the received user credentials.

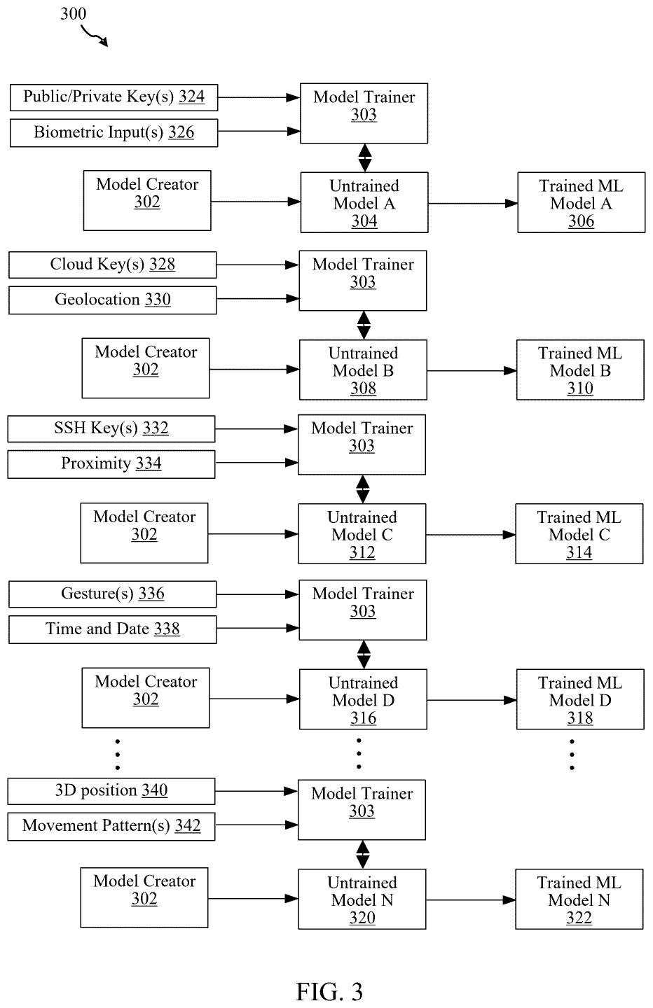

FIG. 3 shows a block diagram of an example model training system 300 utilizing a model creator to create and a model trainer to train multiple machine-learning models with selectable combinations of biometric and/or non-biometric inputs for user authorization, identification, or access, in accordance with an embodiment. As shown in FIG. 300, system 300 includes a model creator 302 and model trainer 303. As shown in FIG. 2, model creator 302 (e.g., authorization model creator 212 of FIG. 2) and model trainer 303 (e.g., authorization model trainer 214 of FIG. 2) may be used by a user accessible environment administrator (referred to as “admin”) (e.g., user 102) to create and train multiple models (e.g., ML model A to ML model N) to create a pool or set of trained ML models. The set of ML models may be selectively deployed for user authentication in one or more user accessible environments using a model deployer (e.g. authorization model deployer 216).

For example, admin may use model creator 302 to create untrained model A 304 by selecting user credentials public and/or private keys 324 and one or more biometric inputs 326. Admin may use model trainer 303 to train untrained model A 304 based on one or more sets of received user credentials public and/or private keys 324 and one or more biometric inputs 326. Model trainer 303 may generate trained ML model A 306.

For example, admin may use model creator 302 to create untrained model B 308 by selecting user credentials cloud key(s) 328 and geolocation 330. Admin may use model trainer 303 to train untrained model B 308 based on one or more sets of received user credentials cloud key(s) 328 and geolocation 330. Model trainer 303 may generate trained ML model B 310.

For example, admin may use model creator 302 to create untrained model C 312 by selecting user credentials SSH key(s) 332 and proximity 334. Admin may use model trainer 303 to train untrained model C 312 based on one or more sets of received user credentials SSH key(s) 332 and proximity 334. Model trainer 303 may generate trained ML model C 314.

For example, admin may use model creator 302 to create untrained model D 316 by selecting user credentials gesture(s) 336 and time and date 338. Admin may use model trainer 303 to train untrained model D 316 based on one or more sets of received user credentials gesture(s) 336 and time and date 338. Model trainer 303 may generate trained ML model D 318.

The process of using model creator 302 and model trainer 303 may continue for as many models as admin would like to create and train or retrain. For example, admin may use model creator 302 to create untrained model N 320 by selecting user credentials 3D position 340 and movement pattern(s) 342. Admin may use model trainer 303 to train untrained model N 320 based on one or more sets of received user credentials 3D position 340 and movement pattern(s) 342. Model trainer 303 may generate trained ML model N 322.

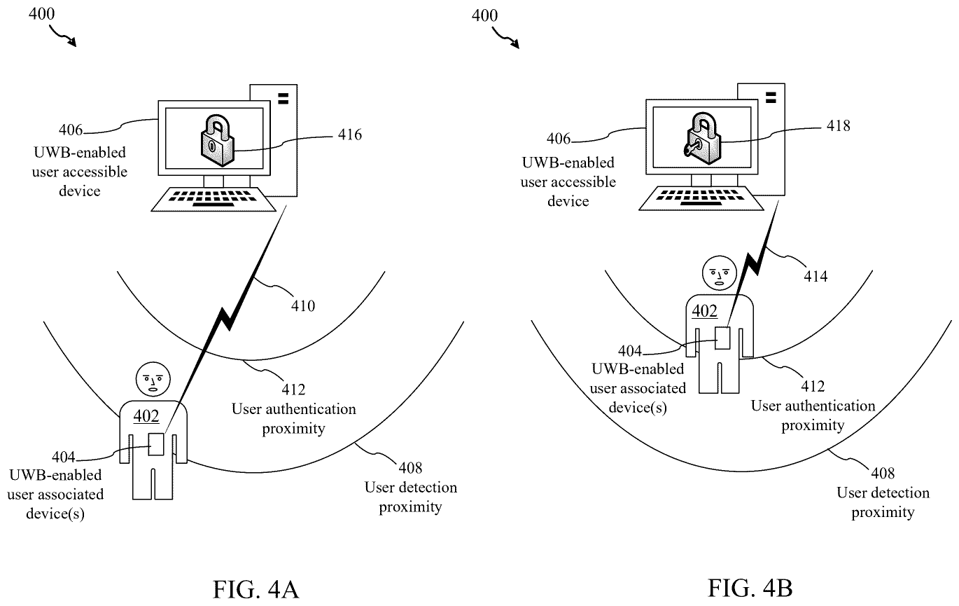

FIGS. 4A and 4B show blocks diagrams of an example system 400 configured for using machine-learning models with biometric and/or non-biometric inputs for user authorization, identification, or access, in accordance with an embodiment. System 400 includes a UWB-enabled accessible device 406 (as an example of a user accessible device 106 of FIG. 1) and one or more UWB-enabled user associated devices 404 (as an example of user associated devices 104 of FIG. 1) associated with a user 402. System 400 is described in further detail as follows.

As shown in FIG. 4A, user 402 with a UWB-enabled user associated device(s) 404 is in the vicinity of a UWB-enabled user accessible device 406. For example, UWB-enabled user accessible device 406 may be the user's laptop computer, desktop computer, cellular phone, tablet, work computer, public computing device (e.g., in a public space with multiple people), building access terminal, etc. The UWB-enabled user accessible device 406 may be running an authenticator service with deployed authentication logic using one or more models (e.g., as shown in FIG. 3). As shown in FIG. 4A, UWB-enabled user accessible device 406 remains locked 416, indicating user 402 is not yet authenticated.

As shown in FIG. 4A, UWB-enabled user accessible device 406 may detect the presence of user 402 at a user detection proximity 408 based on communication 410 with UWB-enabled user associated device(s) 404. The user proximity detection may be provided as a user credential to an authentication service running on the UWB-enabled user accessible device 406. The user authentication service may provide the user proximity credential to one or more trained ML models (e.g., trained model C 314) for inference(s), for example, if/when the user 402 and/or UWB-enabled user associated device(s) 404 is close enough to provide any remaining user credentials required by the deployed authentication logic.

As shown in FIG. 4B, UWB-enabled user accessible device 406 may detect one or more additional user credentials for user 402 at a user authentication proximity 412 based on communication 414 with UWB-enabled user associated device(s) 404. For example, UWB-enabled user associated device(s) 404 may provide one or more secure model keys as one or more additional user credentials. The additional credential(s) (e.g., key(s)) may be provided with the user proximity credential as a set of user credentials to the authentication service running on the UWB-enabled user accessible device 406. The user authentication service may provide the user proximity credential to one or more trained ML models (e.g., trained model C 314) for inference(s), which may be processed by the deployed authentication logic to determine whether user 102 is authenticated by the UWB-enabled user accessible device 406 in a contactless exchange.

In other examples using one or more trained ML models, user 402 may provide, for example, one or more biometric credentials, gestures, movement patterns, etc. upon reaching the user authentication proximity 412.

As shown in FIG. 4B, UWB-enabled user accessible device 406 is unlocked 416, indicating user 402 has been authenticated by deployed authentication logic based on one or more inferences provided by one or more trained ML models analyzing the provided user credentials.

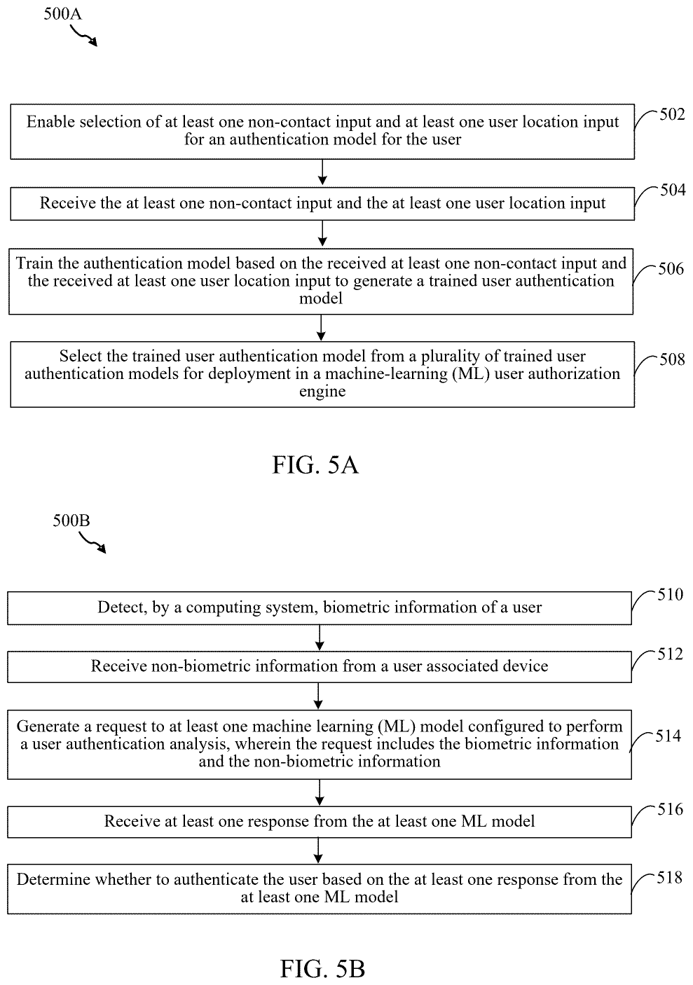

For illustrative purposes, further example operation of user associated device(s) 104/404, user accessible device(s) 106, user accessible device 406, server(s) 110, authenticator 112/122/132/206, authorization manager 114/124/134/202, trained model(s) 116/126/136/220306/310/314/318/322, sensor(s) 118/128/230/232, transceiver(s) 120/130/234, authorization model creator 212/302, authorization model trainer 214/303, authorization model deployer 216, authorization logic 222, model engine 224, and authorization interface 226, shown in FIGS. 1, 2, 3, 4A, and 4B is described below with respect to FIG. 5A. FIG. 5A shows a flowchart 500A of a process for selectively creating, training and deploying ML models for user authorization, identification, or access, in accordance with an embodiment. User associated device(s) 104/404, user accessible device(s) 106, user accessible device 406, server(s) 110, authenticator 112/122/132/206, authorization manager 114/124/134/202, trained model(s) 116/126/136/220306/310/314/318/322, sensor(s) 118/128/230/232, transceiver(s) 120/130/234, authorization model creator 212/302, authorization model trainer 214/303, authorization model deployer 216, authorization logic 222, model engine 224, and authorization interface 226 may operate according to flowchart 500A in embodiments. Note that not all steps of flowchart 500A need be performed in all embodiments. Further structural and operational embodiments will be apparent to persons skilled in the relevant art(s) based on the following description of FIG. 5A.

Flowchart 500A begins with step 502. In step 502, selection is enabled for at least one non-contact input and at least one user location input for an authentication model for the user. For example, as shown in FIGS. 1-3, an admin (e.g., user 102) interacts with (e.g., a graphical user interface (GUI) of) authorization manager 114/124/134/202 (e.g., authorization model creator 212/302) to select user location credentials 150, non-location credentials 140, including non-contact credentials, contact credentials, biometric credentials, non-biometric credentials, etc., for one or more ML models, such as shown by example in FIG. 3.

In step 504, the at least one non-contact input and the at least one user location input are received. For example, as shown in FIGS. 1-3, authorization manager 114/124/134/202 (e.g., authorization model trainer 214/303) receives at least one user location credential 150 and at least one non-location credential 140.

In step 506, the authentication model is trained based on the received at least one non-contact input and the received at least one user location input to generate a trained user authentication model. For example, as shown in FIGS. 1-3, authorization manager 114/124/134/202 (e.g., authorization model trainer 214/303) trains each untrained model 218, 304, 308, 312, 316, 320 based on the received user location credential(s) 150 and non-location credential(s) 140 associated with each respective model to generate the trained model(s) 116/126/136/220306/310/314/318/322. Further description of ML model training is provided elsewhere herein, including with respect to FIG. 6 further below.

In step 508, the trained user authentication model may be selected (e.g., alone or in combination) from a plurality of trained user authentication models for deployment in a machine-learning (ML) user authorization engine. For example, as shown in FIGS. 1-3, an admin (e.g., user 102 of FIG. 1) may use authorization manager 114/124/134/202 (e.g., authorization model deployer 216) to select any one or more trained model(s) 116/126/136/220306/310/314/318/322 for deployment by authenticator 112/122/132/206 via authorization logic 222 and model engine 224.

For illustrative purposes, further example operation of user associated device(s) 104/404, user accessible device 406, server(s) 110, authenticator 112/122/132/206, authorization manager 114/124/134/202, trained model(s) 116/126/136/220306/310/314/318/322, sensor(s) 118/128/230/232, transceiver(s) 120/130/234, authorization model creator 212/302, authorization model trainer 214/303, authorization model deployer 216, authorization logic 222, model engine 224, and authorization interface 226, shown in FIGS. 1, 2, 3, 4A, and 4B are described below with respect to FIG. 5B. FIG. 5B shows a flowchart 500B of a process for using ML models for user authorization, identification, or access, in accordance with an embodiment. User associated device(s) 104/404, user accessible device 406, server(s) 110, authenticator 112/122/132/206, authorization manager 114/124/134/202, trained model(s) 116/126/136/220306/310/314/318/322, sensor(s) 118/128/230/232, transceiver(s) 120/130/234, authorization model creator 212/302, authorization model trainer 214/303, authorization model deployer 216, authorization logic 222, model engine 224, and authorization interface 226 may operate according to flowchart 500B in embodiments. Note that not all steps of flowchart 500B need be performed in all embodiments. Further structural and operational embodiments will be apparent to persons skilled in the relevant art(s) based on the following description of FIG. 5B.

Flowchart 500B begins with step 502. In step 510 a computing system detects biometric information of a user. For example, as shown in FIGS. 1-3, authenticator 112/122/132/206 (e.g., authorization interface 226) in user associated device(s) 104 and/or user accessible device(s) 106, detects biometric information (e.g., face, speech) of user 102 via biometric detector(s) 210 and biometric sensor(s) 232.

In step 512 non-biometric information is received from a user associated device. For example, as shown in FIGS. 1-3, authenticator 122/206 (e.g., authorization interface 226) in user accessible device(s) 106 receives from user associated device(s) 104 non-biometric information (e.g., 3D position, geo-location, RADAR, presence, proximity, gesture(s), key(s), time and date, movement pattern(s)) as user credential(s) of user 102 via non-biometric detector(s) 208 and non-biometric sensor(s) 230.

In step 514, a request is generated to at least one machine learning (ML) model configured to perform a user authentication analysis, wherein the request includes the biometric information and the non-biometric information. For example, as shown in FIGS. 1-3, authenticator 122/206 (e.g., authorization logic 222) generates a request to model engine 224 including the received biometric and non-biometric user credentials for analysis by the trained model(s) 220. Further description of the generation of a response (e.g., an inference) by an ML model is provided elsewhere herein, including with respect to FIG. 6 further below.

In step 516, at least one response is received from the at least one ML model. For example, as shown in FIGS. 1-3, authenticator 122/206 (e.g., authorization logic 222) receives from model engine 224 at least one response (e.g., indicating one or more inferences) generated by the trained model(s) 220.

In step 518, a determination is made whether to authenticate the user based on the at least one response from the at least one ML model. For example, as shown in FIGS. 1-3, authenticator 122/206 (e.g., authorization logic 222) determines whether user 102 is authenticated based on the received at least one response received from ML engine 224.

### III. Example Computing Device Embodiments

User associated device(s) 104, user accessible device(s) 106, server(s) 110, authenticator 112, authorization manager 114, sensor(s) 118, transceiver(s) 120, authenticator 122, authorization manager 124, sensor(s) 128, transceiver(s) 130, authenticator 132, authorization manager 134, user accessible applications 138, authorization manager 202, authenticator 206, non-biometric detector(s) 208, biometric detector(s) 210, non-biometric sensor(s) 230, biometric sensors 232, transceivers 234, authorization model creator 214, authorization model trainer 214, authorization model deployer 216, authorization logic 222, authorization interface 226, location detector 236, non-location detector 238, model engine 224, model creator 302, model trainer 303, flowchart 500A, and flowchart 500B, are implemented in hardware, or hardware combined with one or both of software and/or firmware. For example, authenticator 112, authorization manager 114, sensor(s) 118, transceiver(s) 120, authenticator 122, authorization manager 124, sensor(s) 128, transceiver(s) 130, authenticator 132, authorization manager 134, user accessible applications 138, authorization manager 202, authenticator 206, non-biometric detector(s) 208, biometric detector(s) 210, non-biometric sensor(s) 230, biometric sensors 232, transceivers 234, authorization model creator 214, authorization model trainer 214, authorization model deployer 216, authorization logic 222, authorization interface 226, location detector 236, non-location detector 238, model engine 224, model creator 302, model trainer 303 and/or the components described therein, and/or the steps of flowcharts 500A and 500B are each implemented as computer program code/instructions configured to be executed in one or more processors and stored in a computer readable storage medium. Alternatively, authenticator 112, authorization manager 114, sensor(s) 118, transceiver(s) 120, authenticator 122, authorization manager 124, sensor(s) 128, transceiver(s) 130, authenticator 132, authorization manager 134, user accessible applications 138, authorization manager 202, authenticator 206, non-biometric detector(s) 208, biometric detector(s) 210, non-biometric sensor(s) 230, biometric sensors 232, transceivers 234, authorization model creator 214, authorization model trainer 214, authorization model deployer 216, authorization logic 222, authorization interface 226, location detector 236, non-location detector 238, model engine 224, model creator 302, model trainer 303, and/or the components described therein, and/or the steps of flowcharts 500A and 500B are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 6. FIG. 6 shows a block diagram of an exemplary computing environment 600 that includes a computing device 602. Computing device 602 is an example of each of a user associated device 104, a user accessible device 106 and a server 110, which each include one or more of the components of computing device 602. In some embodiments, computing device 602 is communicatively coupled with devices (not shown in FIG. 6) external to computing environment 600 via network 604. Network 604 comprises one or more networks such as local area networks (LANs), wide area networks (WANs), enterprise networks, the Internet, etc. In examples, network 604 includes one or more wired and/or wireless portions. In some examples, network 604 additionally or alternatively includes a cellular network for cellular communications. Computing device 602 is described in detail as follows.

Computing device 602 can be any of a variety of types of computing devices. Examples of computing device 602 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 602 is a stationary computing device such as a desktop computer, a personal computer (PC), a stationary server device, a minicomputer, a mainframe, a supercomputer, etc.

As shown in FIG. 6, computing device 602 includes a variety of hardware and software components, including a processor 610, a storage 620, a graphics processing unit (GPU) 642, a neural processing unit (NPU) 644, one or more input devices 630, one or more output devices 650, one or more wireless modems 660, one or more wired interfaces 680, a power supply 682, a location information (LI) receiver 684, and an accelerometer 686. Storage 620 includes memory 656, which includes non-removable memory 622 and removable memory 624, and a storage device 688. Storage 620 also stores an operating system 612, application programs 614, and application data 616. Wireless modem(s) 660 include a Wi-Fi modem 662, a Bluetooth modem 664, and a cellular modem 666. Output device(s) 650 includes a speaker 652 and a display 654. Input device(s) 630 includes a touch screen 632, a microphone 634, a camera 636, a physical keyboard 638, and a trackball 640. Not all components of computing device 602 shown in FIG. 6 are present in all embodiments, additional components not shown may be present, and in a particular embodiment any combination of the components are present. In examples, components of computing device 602 are mounted to a circuit card (e.g., a motherboard) of computing device 602, integrated in a housing of computing device 602, or otherwise included in computing device 602. The components of computing device 602 are described as follows.

In embodiments, a single processor 610 (e.g., central processing unit (CPU), microcontroller, a microprocessor, signal processor, ASIC (application specific integrated circuit), and/or other physical hardware processor circuit) or multiple processors 610 are present in computing device 602 for performing such tasks as program execution, signal coding, data processing, input/output processing, power control, and/or other functions. In examples, processor 610 is a single-core or multi-core processor, and each processor core is single-threaded or multithreaded (to provide multiple threads of execution concurrently). Processor 610 is configured to execute program code stored in a computer readable medium, such as program code of operating system 612 and application programs 614 stored in storage 620. The program code is structured to cause processor 610 to perform operations, including the processes/methods disclosed herein. Operating system 612 controls the allocation and usage of the components of computing device 602 and provides support for one or more application programs 614 (also referred to as “applications” or “apps”). In examples, application programs 614 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 610 includes one or more general processors (e.g., CPUs) configured with or coupled to one or more hardware accelerators, such as one or more NPUs 644 and/or one or more GPUs 642.

Any component in computing device 602 can communicate with any other component according to function, although not all connections are shown for ease of illustration. For instance, as shown in FIG. 6, bus 606 is a multiple signal line communication medium (e.g., conductive traces in silicon, metal traces along a motherboard, wires, etc.) present to communicatively couple processor 610 to various other components of computing device 602, although in other embodiments, an alternative bus, further buses, and/or one or more individual signal lines is/are present to communicatively couple components. Bus 606 represents one or more of any of several types of bus structures, including a memory bus or memory controller, a peripheral bus, an accelerated graphics port, and a processor or local bus using any of a variety of bus architectures.

Storage 620 is physical storage that includes one or both of memory 656 and storage device 688, which store operating system 612, application programs 614, and application data 616 according to any distribution. Non-removable memory 622 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 622 includes main memory and is separate from or fabricated in a same integrated circuit as processor 610. As shown in FIG. 6, non-removable memory 622 stores firmware 618 that is present to provide low-level control of hardware. Examples of firmware 618 include BIOS (Basic Input/Output System, such as on personal computers) and boot firmware (e.g., on smart phones). In examples, removable memory 624 is inserted into a receptacle of or is otherwise coupled to computing device 602 and can be removed by a user from computing device 602. Removable memory 624 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 688 are present that are internal and/or external to a housing of computing device 602 and are or are not removable. Examples of storage device 688 include a hard disk drive, a SSD, a thumb drive (e.g., a USB (Universal Serial Bus) flash drive), or other physical storage device.

One or more programs are stored in storage 620. Such programs include operating system 612, one or more application programs 614, and other program modules and program data. Examples of such application programs include computer program logic (e.g., computer program code/instructions) for implementing authenticator 112, authorization manager 114, sensor(s) 118, transceiver(s) 120, authenticator 122, authorization manager 124, sensor(s) 128, transceiver(s) 130, authenticator 132, authorization manager 134, user accessible applications 138, authorization manager 202, authenticator 206, non-biometric detector(s) 208, biometric detector(s) 210, non-biometric sensor(s) 230, biometric sensors 232, transceivers 234, authorization model creator 214, authorization model trainer 214, authorization model deployer 216, authorization logic 222, authorization interface 226, location detector 236, non-location detector 238, model engine 224, model creator 302, and/or model trainer 303, and/or each of the components described therein, as well as any of flowcharts 500A and/or 500B, and/or any individual steps thereof.

Storage 620 also stores data used and/or generated by operating system 612 and application programs 614 as application data 616. Examples of application data 616 include web pages, text, images, tables, sound files, video data, and other data. In examples, application data 616 is sent to and/or received from one or more network servers or other devices via one or more wired or wireless networks. Storage 620 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 602 through one or more input devices 630 and receives information from computing device 602 through one or more output devices 650. Input device(s) 630 includes one or more of touch screen 632, microphone 634, camera 636, physical keyboard 638 and/or trackball 640 and output device(s) 650 includes one or more of speaker 652 and display 654. Each of input device(s) 630 and output device(s) 650 are integral to computing device 602 (e.g., built into a housing of computing device 602) or are external to computing device 602 (e.g., communicatively coupled wired or wirelessly to computing device 602 via wired interface(s) 680 and/or wireless modem(s) 660). Further input devices 630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 654 displays information, as well as operating as touch screen 632 by receiving user commands and/or other information (e.g., by touch, finger gestures, virtual keyboard, etc.) as a user interface. Any number of each type of input device(s) 630 and output device(s) 650 are present, including multiple microphones 634, multiple cameras 636, multiple speakers 652, and/or multiple displays 654.

In embodiments where GPU 642 is present, GPU 642 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 642 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 644 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 628. In an example, NPU 644 is configured for a data-driven parallel computing and is highly efficient at processing massive multimedia data such as videos and images and processing data for neural networks. NPU 644 is configured for efficient handling of AI-related tasks, such as speech recognition, background blurring in video calls, photo or video editing processes like object detection, etc.

In embodiments disclosed herein that implement ML models, NPU 644 can be utilized to execute such ML models, of which MLM 628 is an example. For instance, where applicable, MLM 628 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 644 is used to train MLM 628. To train MLM 628, training data is that includes input features (attributes) and their corresponding output labels/target values (e.g., for supervised learning) is collected. A training algorithm is a computational procedure that is used so that MLM 628 learns from the training data. Examples of training inputs for ML model training include user position, angle, gesture, time of day, location, user crypto, etc. Parameters/weights are internal settings of MLM 628 that are adjusted during training by the training algorithm to reduce a difference between predictions by MLM 628 and actual outcomes (e.g., output labels). In some examples, MLM 628 is set with initial values for the parameters/weights. A loss function measures a dissimilarity between predictions by MLM 628 and the target values, and the parameters/weights of MLM 628 are adjusted to minimize the loss function. The parameters/weights are iteratively adjusted by an optimization technique, such as gradient descent. In this manner, MLM 628 is generated through training by NPU 644 to be used to generate inferences based on received input feature sets for particular applications. MLM 628 is generated as a computer program or other type of algorithm configured to generate an output (e.g., a classification, a prediction/inference) based on received input features and is stored in the form of a file or other data structure.

In examples, such training of MLM 628 by NPU 644 is supervised or unsupervised. According to supervised learning, input objects (e.g., a vector of predictor variables) and a desired output value (e.g., a human-labeled supervisory signal) train MLM 628. The training data is processed, building a function that maps new data on expected output values. Example algorithms usable by NPU 644 to perform supervised training of MLM 628 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 628 is an LLM, MLM 628 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 628 is trained to learn patterns from unlabeled data. For instance, in embodiments where MLM 628 implements unsupervised learning techniques, MLM 628 identifies one or more classifications or clusters to which an input belongs. During a training phase of MLM 628 according to unsupervised learning, MLM 628 tries to mimic the provided training data and uses the error in its mimicked output to correct itself (i.e., correct weights and biases). In further examples, NPU 644 perform unsupervised training of MLM 628 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 644 need not necessarily be present in all ML model embodiments. In embodiments where ML models are present, any one or more of processor 610, GPU 642, and/or NPU 644 can be present to train and/or execute MLM 628.

One or more wireless modems 660 can be coupled to antenna(s) (not shown) of computing device 602 and can support two-way communications between processor 610 and devices external to computing device 602 through network 604, as would be understood to persons skilled in the relevant art(s). Wireless modem 660 is shown generically and can include a cellular modem 666 for communicating with one or more cellular networks, such as a GSM network for data and voice communications within a single cellular network, between cellular networks, or between the mobile device and a public switched telephone network (PSTN). In examples, wireless modem 660 also or alternatively includes other radio-based modem types, such as a Bluetooth modem 664 (also referred to as a “Bluetooth device”) and/or Wi-Fi modem 662 (also referred to as an “wireless adaptor”). Wi-Fi modem 662 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 664 is configured to communicate with another Bluetooth-capable device according to the Bluetooth short-range wireless technology standard(s) such as IEEE 802.15.1 and/or managed by the Bluetooth Special Interest Group (SIG).

Computing device 602 can further include power supply 682, LI receiver 684, accelerometer 686, and/or one or more wired interfaces 680. Example wired interfaces 680 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 680 of computing device 602 provide for wired connections between computing device 602 and network 604, or between computing device 602 and one or more devices/peripherals when such devices/peripherals are external to computing device 602 (e.g., a pointing device, display 654, speaker 652, camera 636, physical keyboard 638, etc.). Power supply 682 is configured to supply power to each of the components of computing device 602 and receives power from a battery internal to computing device 602, and/or from a power cord plugged into a power port of computing device 602 (e.g., a USB port, an A/C power port). LI receiver 684 is useable for location determination of computing device 602 and in examples includes a satellite navigation receiver such as a Global Positioning System (GPS) receiver and/or includes other type of location determiner configured to determine location of computing device 602 based on received information (e.g., using cell tower triangulation, etc.). Accelerometer 686, when present, is configured to determine an orientation of computing device 602.

Note that the illustrated components of computing device 602 are not required or all-inclusive, and fewer or greater numbers of components can be present as would be recognized by one skilled in the art. In examples, computing device 602 includes one or more of a gyroscope, barometer, proximity sensor, ambient light sensor, digital compass, etc. In an example, processor 610 and memory 656 are co-located in a same semiconductor device package, such as being included together in an integrated circuit chip, FPGA, or system-on-chip (SOC), optionally along with further components of computing device 602.

In embodiments, computing device 602 is configured to implement any of the above-described features of flowcharts herein. Computer program logic for performing any of the operations, steps, and/or functions described herein is stored in storage 620 and executed by processor 610.

In some embodiments, server infrastructure 670 is present in computing environment 600 and is communicatively coupled with computing device 602 via network 604. Server infrastructure 670, when present, is a network-accessible server set (e.g., a cloud-based environment or platform). As shown in FIG. 6, server infrastructure 670 includes clusters 672. Each of clusters 672 comprises a group of one or more compute nodes and/or a group of one or more storage nodes. For example, as shown in FIG. 6, cluster 672 includes nodes 674. Each of nodes 674 are accessible via network 604 (e.g., in a “cloud-based” embodiment) to build, deploy, and manage applications and services. In examples, any of nodes 674 is a storage node that comprises a plurality of physical storage disks, SSDs, and/or other physical storage devices that are accessible via network 604 and are configured to store data associated with the applications and services managed by nodes 674.

Each of nodes 674, as a compute node, comprises one or more server computers, server systems, and/or computing devices. For instance, a node 674 in accordance with an embodiment includes one or more of the components of computing device 602 disclosed herein. Each of nodes 674 is configured to execute one or more software applications (or “applications”) and/or services and/or manage hardware resources (e.g., processors, memory, etc.), which are utilized by users (e.g., customers) of the network-accessible server set. In examples, as shown in FIG. 6, nodes 674 includes a node 646 that includes storage 648 and/or one or more of a processor 658 (e.g., similar to processor 610, GPU 642, and/or NPU 644 of computing device 602). Storage 648 stores application programs 676 and application data 678. Processor(s) 658 operate application programs 676 which access and/or generate related application data 678. In an implementation, nodes such as node 646 of nodes 674 operate or comprise one or more virtual machines, with each virtual machine emulating a system architecture (e.g., an operating system), in an isolated manner, upon which applications such as application programs 676 are executed.

In embodiments, one or more of clusters 672 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 672 are included in a datacenter in a distributed collection of datacenters. In embodiments, exemplary computing environment 600 comprises part of a cloud-based platform.

In an embodiment, computing device 602 accesses application programs 676 for execution in any manner, such as by a client application and/or a browser at computing device 602.

In an example, for purposes of network (e.g., cloud) backup and data security, computing device 602 additionally and/or alternatively synchronizes copies of application programs 614 and/or application data 616 to be stored at network-based server infrastructure 670 as application programs 676 and/or application data 678. In examples, operating system 612 and/or application programs 614 include a file hosting service client configured to synchronize applications and/or data stored in storage 620 at network-based server infrastructure 670.

In some embodiments, on-premises servers 692 are present in computing environment 600 and are communicatively coupled with computing device 602 via network 604. On-premises servers 692, when present, are hosted within an organization's infrastructure and, in many cases, physically onsite of a facility of that organization. On-premises servers 692 are controlled, administered, and maintained by IT (Information Technology) personnel of the organization or an IT partner to the organization. Application data 698 can be shared by on-premises servers 692 between computing devices of the organization, including computing device 602 (when part of an organization) through a local network of the organization, and/or through further networks accessible to the organization (including the Internet). Furthermore, in examples, on-premises servers 692 serve applications such as application programs 696 to the computing devices of the organization, including computing device 602. Accordingly, in examples, on-premises servers 692 include storage 694 (which includes one or more physical storage devices such as storage disks and/or SSDs) for storage of application programs 696 and application data 698 and include a processor 690 (e.g., similar to processor 610, GPU 642, and/or NPU 644 of computing device 602) for execution of application programs 696. In some embodiments, multiple processors 690 are present for execution of application programs 696 and/or for other purposes. In further examples, computing device 602 is configured to synchronize copies of application programs 614 and/or application data 616 for backup storage at on-premises servers 692 as application programs 696 and/or application data 698.

Embodiments described herein may be implemented in one or more of computing device 602, network-based server infrastructure 670, and on-premises servers 692. For example, in some embodiments, computing device 602 is used to implement systems, clients, or devices, or components/subcomponents thereof, disclosed elsewhere herein. In other embodiments, a combination of computing device 602, network-based server infrastructure 670, and/or on-premises servers 692 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 620. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 614) are stored in storage 620. Such computer programs can also be received via wired interface(s) 660 and/or wireless modem(s) 660 over network 604. Such computer programs, when executed or loaded by an application, enable computing device 602 to implement features of embodiments discussed herein. Accordingly, such computer programs represent controllers of the computing device 602.

Embodiments are also directed to computer program products comprising computer code or instructions stored on any computer-readable medium or computer-readable storage medium. Such computer program products include the physical storage of storage 620 as well as further physical storage types.

### VI. Additional Example Embodiments

Systems, methods, and instrumentalities are described herein related to secure artificial intelligence (AI) authentication and interaction. Authentication, such as image recognition or AI detection models, are implemented with a security algorithm, such as those using cryptography. For example, AI authorization augmented with an ultra-wideband (UWB) communication protocol provides robust user authentication via a native cryptographic exchange and accurate user location for proximity and geo-fenced interaction. Authentication utilizing UWB-enabled devices provides a wireless and seamless extension of security provided by secure platforms modules (e.g., smart cards, trusted platform modules (TPMs), and Secure Elements) used in payment, enterprise systems, and other secure environments. AI systems combined with accurate and secure position sensing (e.g., enabled by UWB signaling) enables secure user access to secure accounts, files, payment, identity sensitive applications, etc. without requiring deliberate user authentication. User privacy can be maintained by using cryptography to obfuscate unique identifiers in broadcast beacons. Real time location data from UWB communications, such as Time of Flight (ToF) and Angle of Arrival (AoA) provides high precision (e.g., within 5 cm or 5 degrees), can be used to improve the context of user credential information provided to AI engines, such as voice, audio, and/or other metadata. For example, UWB metadata may be added to an AI voice command or image log-in to confirm to the secure system that the person claiming access is authenticated and that his/her location is within a pre-programmed geo-fence position.

As described herein by example, a method of selectively creating, training and deploying ML models for user authorization, identification, or access, comprises: enabling selection of at least one non-contact input from a plurality of non-contact inputs and at least one user location input from a plurality of user location inputs for an authentication model for the user; receiving the at least one non-contact input and the at least one user location input; training the authentication model based on the received at least one non-contact input and the received at least one user location input to generate a trained user authentication model; and selecting at least one trained user authentication model from a plurality of trained user authentication models for deployment in an ML user authorization engine.

As described herein by example, a method of using ML models for user authorization, identification, or access, comprises: detecting, by a computing system, biometric information of a user; receiving non-biometric information from a user associated device; generating a request to at least one ML model configured to perform a user authentication analysis, wherein the request includes the biometric information and the non-biometric information; receiving at least one response from the at least one ML model; and authenticating the user based on the at least one response from the at least one ML model. Selection of the at least one ML model for the request may vary based on at least one of the biometric information or the non-biometric information. In this manner, an ML model tailored to the specific type of received biometric information and specific type of received non-biometric information can be used for authentication, which leads to higher accuracy authentication relative to using more general purpose ML models. Selection of at least one of the biometric information from a plurality of biometric information or the non-biometric information from a plurality of non-biometric information may vary based on at least one parameter.

As described herein by example, a system comprises a location detector, a non-location detector, and an authenticator. The location detector is configured to wirelessly detect at least one user location credential. The non-location detector is configured to wirelessly detect at least one non-location credential of a user. The authenticator is configured to generate a request to at least one machine learning (ML) model configured to perform a user authentication analysis, wherein the request includes the at least one user location credential and the at least one non-location credential; receive at least one user authentication response from the at least one ML model; and determine whether to authenticate the user based on the at least one user authentication response from the at least one ML model.

In examples, a model may be set up for use by creating the model with one or more user credentials, training the model with the selected credentials, and selecting the model for deployment.

In examples, a method may be implemented in at least one computing device. The method may comprise, for example, enabling selection of at least one non-contact input (e.g., from a plurality of possible non-contact inputs) and at least one user location input (e.g., from a plurality of possible user location inputs) for an authentication model for the user; receiving the at least one non-contact input and the at least one user location input; and training the authentication model based on the received at least one non-contact input and the received at least one user location input to generate a trained user authentication model.

In examples, the method further comprises interacting with the trained user authentication model to authenticate the user; and providing access to a secure account by the user based on the authenticating.

In examples, the at least one non-contact input may comprise at least one of a biometric input, a gesture input, or a movement pattern input. Furthermore, the at least one user location input may indicate at least one of proximity, geolocation, three-dimensional (3D) position, or presence detection

In examples, the method may further comprise signing the trained user authentication model with a model authentication key to generate a trained secure user authentication model.

In examples, the at least one non-contact input may comprise at least one of a public key, a private key, a cloud key, or an SSH key.

In examples, the at least one user location input may indicate at least one of proximity, geolocation, three-dimensional (3D) position, or presence detection (e.g., radar).

In examples, the at least one user location input may be generated by an ultra-wideband (UWB) enabled device.

In examples, the method may further comprise selecting at least one trained user authentication model from a plurality of trained user authentication models for deployment in a machine-learning (ML) user authorization engine.

In examples, one or more deployed trained models may be used to generate inferences based on received user credentials.

In examples, a method may be implemented in at least one computing device. The method may comprise, for example, detecting, by a computing system, biometric information of a user; receiving non-biometric information from a user associated device; generating a request to at least one machine learning (ML) model configured to perform a user authentication analysis, wherein the request includes the biometric information and the non-biometric information; receiving at least one response from the at least one ML model; and determining whether to authenticate the user based on the at least one response from the at least one ML model.

In examples, the method may further comprise varying selection of the at least one ML model for the request based on at least one of the biometric information or the non-biometric information (e.g., by time of day or angle of arrival).

In examples, the method may further comprise varying selection of at least one of the biometric information from a plurality of biometric information or the non-biometric information from a plurality of non-biometric information based on at least one parameter (e.g., by time of day or angle of arrival).

In examples, the non-biometric information may comprise user proximity information indicating a location of a user or a location of the user associated device.

In examples, the method may further comprise determining the user proximity information based on a secure challenge to authenticate the biometric information.

In examples, the method may further comprise communicating with the user associated device to determine the user proximity information.

In examples, the communication may be encrypted or obfuscated based on rolling identifiers (IDs).

In examples, the user associated device may comprise an ultra-wideband (UWB) enabled device.

In examples, the determination of the user proximity information may be based on at least one of a time of flight or an angle of arrival for a communication from the user associated device.

In examples, the determination whether to authenticate the user may be based, at least in part, on an indication by the user proximity information that the user is located within a geo-fence position threshold.

In examples, the at least one ML model may include at least one secure ML model.

In examples, the method may further comprise obtaining secure key material for encrypted communication with the device associated with the user from the user associated device or from a network server indicated by the user associated device.

In examples, the user associated device may comprise a secure platform module comprising at least one of a trusted platform module (TPM), a smart card, or a secure element.

In examples, the method may further comprise granting or denying access to resources, data, or a computing system based on the determination.

In examples, the method may further comprise performing or not performing a payment transaction based on the determination.

In examples, the method may further comprise pairing or not pairing an input/output/peripheral device (pen, mouse, keyboard, headset) with the computing system based on the determination.

In examples, a computing device or system may comprise one or more processors and one or more memory devices that store program code configured to be executed by the one or more processors.

In examples, a system may comprise a location detector, a non-location detector, and an authenticator. Thea location detector may be configured to wirelessly detect at least one user location credential. The non-location detector may be configured to wirelessly detect at least one non-location credential of a user. The authenticator may be configured to: generate a request to at least one machine learning (ML) model configured to perform a user authentication analysis, wherein the request includes the at least one user location credential and the at least one non-location credential; receive at least one user authentication response from the at least one ML model; and determine whether to authenticate the user based on the at least one user authentication response from the at least one ML model.

In examples, the at least one non-location credential may comprise at least one of a user biometric credential, a user gesture credential, or a user movement pattern credential.

In examples, the at least one non-location credential may comprise at least one of a public key, a private key, a cloud key, or an SSH key.

In examples, the at least one location credential may indicate at least one of proximity, geolocation, three-dimensional (3D) position, or presence detection of the user or a user associated device.

In examples, the at least one user location credential may be generated by an ultra-wideband (UWB) enabled device.

In examples, the authenticator may be further configured to vary selection of the at least one ML model for the request based on at least one of the location credential or the non-location credential (e.g., by time of day or angle of arrival).

In examples, the authenticator may be further configured to vary selection of at least one of the at least one location credential from a plurality of location credentials or the at least one non-location credential from a plurality of non-location credentials based on at least one parameter (e.g., by time of day or angle of arrival).

In examples, the authenticator may be further configured to cause the location detector to detect the at least one user location credential based on a secure challenge to authenticate the at least one non-location credential.

In examples, a computer-readable storage medium is described herein. The computer-readable storage medium has program instructions recorded thereon that, when executed by a processor, implements a method, such as any method described herein.

### VII. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

For example, running examples have been described with respect to malicious activity detectors determining whether compute resource creation operations potentially correspond to malicious activity. However, it is also contemplated herein that malicious activity detectors may be used to determine whether other types of control plane operations potentially correspond to malicious activity.

Several types of impactful operations have been described herein; however, lists of impactful operations may include other operations, such as, but not limited to, accessing enablement operations, creating and/or activating new (or previously-used) user accounts, creating and/or activating new subscriptions, changing attributes of a user or user group, changing multi-factor authentication settings, modifying federation settings, changing data protection (e.g., encryption) settings, elevating another user account's privileges (e.g., via an admin account), retriggering guest invitation e-mails, and/or other operations that impact the cloud-base system, an application associated with the cloud-based system, and/or a user (e.g., a user account) associated with the cloud-based system.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system, comprising:
a location detector configured to wirelessly detect at least one user location credential;
a non-location detector configured to wirelessly detect at least one non-location credential of a user;
an authenticator configured to:
generate a request to at least one machine learning (ML) model configured to perform a user authentication analysis, wherein the request includes the at least one user location credential and the at least one non-location credential;
receive at least one user authentication response from the at least one ML model; and
determine whether to authenticate the user based on the at least one user authentication response from the at least one ML model.

2. The system of claim 1, wherein the at least one non-location credential comprises at least one of a user biometric credential, a user gesture credential, or a user movement pattern credential.

3. The system of claim 1, wherein the at least one non-location credential comprises at least one of a public key, a private key, a cloud key, or an SSH key.

4. The system of claim 1, wherein the at least one location credential indicates at least one of proximity, geolocation, three-dimensional (3D) position, or presence detection of the user or a user associated device.

5. The system of claim 1, wherein the authenticator is further configured to:
vary selection of the at least one ML model for the request based on at least one of the location credential or the non-location credential.

6. A method, comprising:
detecting, by a computing system, biometric information of a user;
receiving non-biometric information from a user associated device;
generating a request to at least one machine learning (ML) model configured to perform a user authentication analysis, wherein the request includes the biometric information and the non-biometric information;
receiving at least one response from the at least one ML model; and
determining whether to authenticate the user based on the at least one response from the at least one ML model.

7. The method of claim 6, further comprising:
varying selection of the at least one ML model for the request based on at least one of the biometric information or the non-biometric information.

8. The method of claim 6, further comprising:
varying selection of at least one of the biometric information from a plurality of biometric information or the non-biometric information from a plurality of non-biometric information based on at least one parameter.

9. The method of claim 6, wherein the non-biometric information comprises user proximity information indicating a location of a user or a location of the user associated device.

10. The method of claim 9, further comprising:
determining the user proximity information based on a secure challenge to authenticate the biometric information.

11. The method of claim 6, wherein the user associated device comprises an ultra-wideband (UWB) enabled device.

12. The method of claim 11, wherein the determination of the user proximity information is based on at least one of a time of flight or an angle of arrival for a communication from the user associated device.

13. The method of claim 9, wherein the determination whether to authenticate the user is based, at least in part, on an indication by the user proximity information that the user is located within a geo-fence position threshold.

14. A method, comprising:
enabling selection of at least one non-contact input and at least one user location input for an authentication model for the user;
receiving the at least one non-contact input and the at least one user location input; and
training the authentication model based on the received at least one non-contact input and the received at least one user location input to generate a trained user authentication model.

15. The method of claim 14, further comprising:
interacting with the trained user authentication model to authenticate the user; and
providing access to a secure account by the user based on the authenticating.

16. The method of claim 14, wherein the at least one non-contact input comprises at least one of a biometric input, a gesture input, or a movement pattern input; and
the at least one user location input indicates at least one of proximity, geolocation, three-dimensional (3D) position, or presence detection.

17. The method of claim 14, further comprising:
signing the trained user authentication model with a model authentication key to generate a trained secure user authentication model.

18. The method of claim 14, wherein the at least one non-contact input comprises at least one of a public key, a private key, a cloud key, or an SSH key.

19. The method of claim 14, wherein the at least one user location input is generated by an ultra-wideband (UWB) enabled device.

20. The method of claim 14, further comprising:
selecting the trained user authentication model from a plurality of trained user authentication models for deployment in a machine-learning (ML) user authorization engine.
